(19) United States
(12) Patent Application Publication
(10) Pub. No.: US 2004/0252981 A1
(43) Pub. Date: Dec. 16, 2004

(54) Encoder, encoding method, decoder, decoding method, recorder, recording method, player, and playing method

(76) Inventor: Takayuki Murayama, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/835,710

(22) Filed: Apr. 30, 2004

(30) Foreign Application Priority Data
May 16, 2003 (JP) P2003-139015

(51) Int. Cl. H04N 5/76

(52) U.S. Cl. 386/111; 386/112

(57) ABSTRACT

An encoder according to the present invention includes an encoding unit for encoding an input video or audio signal into an elementary stream; a creating unit for creating elementary stream buffer index information on the elementary stream; and a storing unit for storing the elementary stream encoded by the encoding unit and the elementary stream buffer index information created by the creating unit.

### BACKGROUND OF THE INVENTION

1. Field of the Invention

The present invention relates to encoders, encoding methods, decoders, decoding methods, recorders, recording methods, players, and playing methods, and more particularly, to an encoder, an encoding method, a decoder, a decoding method, a recorder, a recording method, a player, and a playing method capable of efficiently performing encoding and decoding processing in a recorder/player.

2. Description of the Related Art

Recently, technologies for compressing and recording image data and audio data have advanced. For example, a moving picture experts group (MPEG) system is a highly efficient compression system.

For example, in a known recorder/player that records image or audio data on an optical disc and that plays the image or audio data recorded on the optical disc using the MPEG system, functions, such as recording monitoring, re-encoding of a stream, conversion of a format, and transcoding, are important. Also, real-time and high-speed processing is required for the known recorder/player.

When an encoded image signal is decoded and then the decoded image is re-encoded, the quality of the image deteriorates due to a difference in encoding parameters. For example, technologies for reducing the deterioration of the image quality by using the same encoding parameter for re-encoding as the parameter used for the primary encoding are disclosed in Japanese Unexamined Patent Application Publication Nos. 11-234675 and 11-313331.

According to the technologies described above, however, all the video and audio streams must be re-encoded, and this causes inefficient processing.

### SUMMARY OF THE INVENTION

Accordingly, it is an object of the present invention to efficiently perform processing, such as re-encoding, by establishing common interfaces between an encoding side and a decoding side.

An encoder according to the present invention includes an encoding unit for encoding an input video or audio signal into an elementary stream; a creating unit for creating elementary stream buffer index information on the elementary stream; and a storing unit for storing the elementary stream encoded by the encoding unit and the elementary stream buffer index information created by the creating unit.

An encoding method according to the present invention includes an encoding step of encoding an input video or audio signal into an elementary stream; a creating step of creating elementary stream buffer index information on the elementary stream; and a storage controlling step of controlling storage of the elementary stream encoded by the encoding step and the elementary stream buffer index information created by the creating step.

Accordingly, an input video or audio signal can be encoded. In particular, the video or audio signal can be encoded by using interfaces common between an encoding side and a decoding side.

A decoder according to the present invention includes a storing unit for storing an elementary stream and elementary stream buffer index information on the elementary stream; and a decoding unit for decoding the elementary stream in accordance with the elementary stream buffer index information stored in the storing unit.

A decoding method according to the present invention includes a storage controlling step of controlling storage of an elementary stream and elementary stream buffer index information on the elementary stream; and a decoding step of decoding the elementary stream in accordance with the elementary stream buffer index information stored by the storage controlling step.

Accordingly, a stream can be decoded. In particular, the stream can be decoded by using interfaces common between an encoding side and a decoding side.

A recorder according to the present invention includes an encoding unit for encoding an input video or audio signal into an elementary stream; a first storing unit for storing the elementary stream encoded by the encoding unit; a creating unit for creating elementary stream buffer index information on the elementary stream; a second storing unit for storing the elementary stream buffer index information created by the creating unit; a multiplexing unit for multiplexing the elementary stream stored in the first storing unit in accordance with the elementary stream buffer index information stored in the second storing unit; and a recording unit for recording a bit stream multiplexed by the multiplexing unit in an external storage unit.

A recording method according to the present invention includes an encoding step of encoding an input video or audio signal into an elementary stream; a first storage controlling step of controlling storage of the elementary stream encoded by the encoding step; a creating step of creating elementary stream buffer index information on the elementary stream; a second storage controlling step of controlling storage of the elementary stream buffer index information created by the creating step; a multiplexing step of multiplexing the elementary stream stored by the first storage controlling step in accordance with the elementary stream buffer index information stored by the second storage controlling step; and a recording controlling step of controlling recording of a bit stream multiplexed by the multiplexing step in an external storage unit.

Accordingly, an input video or audio signal can be encoded and recorded. In particular, since the video or audio signal is encoded and recorded by using interfaces common between a recording side and a playing side, the redundancy of the processing can be reduced.

A player according to the present invention includes a separating unit for separating a bit stream recorded in an external storage unit into elementary streams; a first storing unit for storing the elementary streams separated by the separating unit; a creating unit for creating elementary stream buffer index information on the elementary streams; a second storing unit for storing the elementary stream buffer index information created by the creating unit; a decoding unit for decoding the elementary streams stored in the first storing unit in accordance with the elementary stream buffer index information stored in the second storing unit; and a playing unit for playing a video or audio signal decoded by the decoding unit.

A playing method according to the present invention includes a separating step of separating a bit stream recorded in an external storage unit into elementary streams; a first storage controlling step of controlling storage of the elementary streams separated by the separating step; a creating step of creating elementary stream buffer index information on the elementary streams; a second storage controlling step of controlling storage of the elementary stream buffer index information created by the creating step; a decoding step of decoding the elementary streams stored by the first storage controlling step in accordance with the elementary stream buffer index information stored by the second storage controlling step; and a playing controlling step of controlling playing of a video or audio signal decoded by the decoding step.

Accordingly, a stream can be decoded and played. In particular, since the stream is decoded and played by using interfaces common between a recording side and a playing side, the redundancy of the processing can be reduced.

### BRIEF DESCRIPTION OF THE DRAWINGS

FIG. 1 shows an example of the structure of a recorder/player according to the present invention;

FIG. 2 shows the format of a digital versatile disc (DVD) stream according to an embodiment of the present invention;

FIG. 3 is a flowchart for explaining playing control processing;

FIG. 4 is a flowchart for explaining recording control processing;

FIG. 5 is a flowchart for explaining access unit search processing;

FIG. 6 is a flowchart for explaining re-encoding processing;

FIG. 7 is a flowchart for explaining format conversion processing;

FIG. 8 is a flowchart for explaining recording monitoring processing; and

FIG. 9 is a block diagram showing an example of the structure of a computer.

### DESCRIPTION OF THE PREFERRED EMBODIMENTS

Embodiments of the present invention will be described with reference to the drawings.

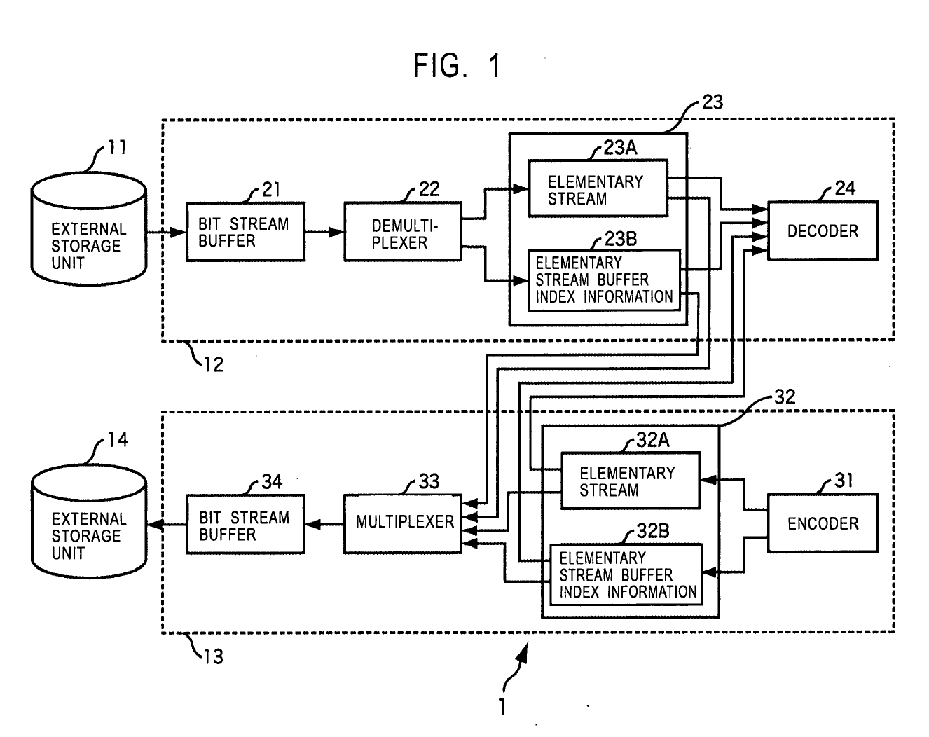

FIG. 1 shows an example of the structure of a recorder/player 1 according to the present invention. Referring to FIG. 1, the recorder/player 1 includes a playing control part 12 and a recording control part 13. The playing control part 12 includes a bit stream buffer 21, a demultiplexer (separator) 22, an elementary stream buffer 23, and a decoder 24. The recording control part 13 includes an encoder 31, an elementary stream buffer 32, a multiplexer 33, and a bit stream buffer 34.

The demultiplexer 22 causes a bit stream recorded in an external storage unit 11 to be output to the bit stream buffer 21 and to be stored in the bit stream buffer 21. The demultiplexer 22 also reads the bit stream stored in the bit stream buffer 21 and separates the bit stream into elementary streams of video and audio by predetermined demultiplexing processing. Each of the elementary streams is output to an elementary stream region 23A of the elementary stream buffer 23 for each access unit, which is a unit for decoding and playing, to be stored in the elementary stream region 23A. The demultiplexer 22 creates elementary stream buffer index information for determining the beginning and the size of each access unit, and outputs the elementary stream buffer index information to an elementary stream buffer index information region 23B, which is different from the elementary stream region 23A storing the elementary streams, to be stored in the elementary stream buffer index information region 23B.

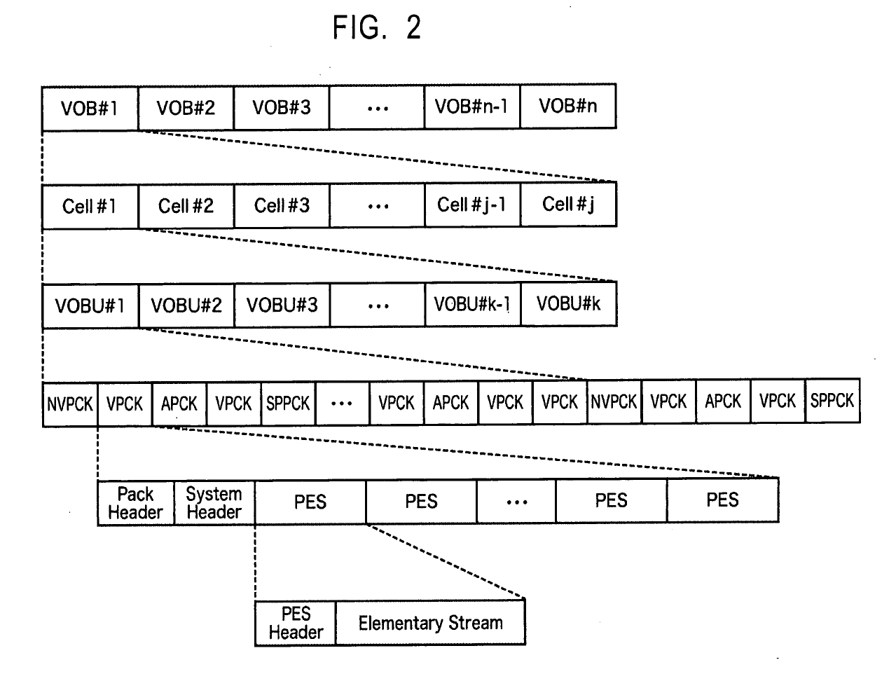

The format of a digital versatile disc (DVD) stream according to this embodiment will now be described with reference to FIG. 2.

The DVD stream includes video objects (VOBs) 1 to n. In each of the video objects, presentation data and navigation information for playing actual video are structured in a pack or packet defined by a system part of the MPEG2 standard. The presentation data includes video data, audio data, sub-video data, and the like.

Also, each of the video objects includes cells 1 to j. Each of the cells is a scene in a title determined by a maker and is a basic unit for playing the title. One or more cells are defined in each of the video objects.

Also, each of the cells includes video object units (VOBUs) 1 to k. Each of the video object units is a minimum unit for access by the reader/player 1.

Each of the video object units includes a navigation pack (NVPCK), a video pack (VPCK), an audio pack (APCK), and a sub-picture pack (SPPCK). The navigation pack includes navigation information, the video pack includes video data as presentation data, the audio pack includes audio data as presentation data, and the sub-picture pack includes sub-video data as presentation data.

The video pack includes a pack header, a system header, and a plurality of packetized elementary streams (PESs). An identifier and various flags for identifying a packet are written in the pack header. An identifier and various flags for identifying a system are written in the system header.

Each of the PESs includes a PES header and an elementary stream. A code for identifying a stream (for example, a stream ID), the size of a packet, time information for synchronized playing, such as a presentation time stamp (PTS) and a decoding time stamp (DTS), and other control information are written in the PES header. A video stream is written in the elementary stream.

As described above, the time stamps representing the time for decoding video or audio and the time for playing the video or audio in reference time are written in the DTS and PTS of the PES header for each access unit representing a unit for decoding and playing video or audio.

Since the information, such as the PTS and the DTS for the access unit, is lost at the level of the elementary stream, the elementary stream buffer index information corresponding to each access unit is created by the demultiplexer 22, and the created elementary stream buffer index information is output as access unit information to the elementary stream buffer index information region 23B, which is different from the elementary stream region 23A storing the elementary stream, of the elementary stream buffer 23.

In addition to the PTS and the DTS, the elementary stream buffer index information includes feature information (an entry point) of the access unit. Due to the entry point, random access to the stream can be realized.

Referring back to FIG. 1, the elementary stream buffer 23 includes the elementary stream region 23A storing an elementary stream for each access unit and the elementary stream buffer index information region 23B storing elementary stream buffer index information for each access unit.

The decoder 24 reads a predetermined access unit stored in the elementary stream region 23A in accordance with the elementary stream buffer index information stored in the elementary stream buffer index information region 23B of the elementary stream buffer 23, and decodes the read access unit using, for example, the MPEG system. The decoded baseband video signal is output to a display (not shown) via a video output terminal, and the decoded baseband audio signal is output to a speaker (not shown) via an audio output terminal.

Also, when the recording control part 13 monitors a bit stream being recorded in an external storage unit 14, the decoder 24 reads an access unit that is stored in an elementary stream region 32A and that is being recorded in accordance with elementary stream buffer index information stored in an elementary stream buffer index information region 32B of the elementary stream buffer 32, and decodes the access unit using, for example, the MPEG system. Accordingly, video corresponding to the video signal being recorded is displayed on the display and audio corresponding to the audio signal being recorded is played through the speaker.

The encoder 31 encodes the input video signal and/or audio signal using, for example, the MPEG system to create an elementary stream for each access unit. Also, the encoder 31 outputs the created elementary stream to the elementary stream region 32A to be stored in the elementary stream region 32A. At this time, the encoder 31 creates elementary stream buffer index information for determining the beginning and the size of each access unit, and outputs the elementary stream buffer index information to the elementary stream buffer index information region 32B, which is different from the elementary stream region 32A storing the elementary stream, of the elementary stream buffer 32 to be stored in the elementary stream buffer index information region 32B.

Also, for re-encoding the decoded video signal and audio signal, the encoder 31 re-encodes the video signal decoded by the decoder 24 using, for example, the MPEG system. For audio, audio stored (held) in the elementary stream region 32A of the elementary stream buffer 32 when the primary encoding was performed is utilized.

Re-encoding is performed for the purpose of reducing the size of all the streams by converting the encoding bit rate of each of the streams. Normally, all the streams are decoded to baseband signals, and then are encoded again at a low bit rate. Such bit rate conversion directly affects the size of a video stream, but hardly affects the size of an audio stream. In this embodiment, only a decoded video signal is re-encoded and the audio encoded by the primary encoding is utilized. Accordingly, the redundancy of the processing is reduced and the deterioration of the quality of audio is prevented.

The multiplexer 33 reads a predetermined access unit stored in the elementary stream region 32A in accordance with the elementary stream buffer index information stored in the elementary stream buffer index information region 32B of the elementary stream buffer 32 to be multiplexed into a bit stream by predetermined multiplexing processing. The multiplexed bit stream is output to the bit stream buffer 34 to be stored in the bit stream buffer 34. The multiplexer 33 also reads the bit stream stored in the bit stream buffer 34 at a predetermined timing, and outputs the read bit stream to the external storage unit 14 to be recorded in the external storage unit 14.

For example, for MPEG system stream conversion, such as converting a program stream into a transport stream or converting a transport stream into a program stream, or DVD stream format conversion, such as converting a DVD-Video format into a DVD-VR format or converting a DVD-VR format into a DVD-Video format, the multiplexer 33 reads a desired access unit stored in the elementary stream region 23A in accordance with the elementary stream buffer index information stored in the elementary stream buffer index information region 23B of the elementary stream buffer 23, and multiplexes the read access unit to be format-converted.

As described above, arranging the relationship from the bit stream buffer 21 to the decoder 24 in the playing control part 12 (decoding side) symmetrically to the relationship from the encoder 31 to the bit stream buffer 34 in the recording control part 13 (encoding side) realizes common physical structures between the playing control part 12 and the recording control part 13. Also, the elementary stream buffer index information created by each of the decoding side and encoding side has the same format.

Each of the external storage units 11 and 14 includes, for example, a high-capacity, next-generation optical disc capable of recording large amounts of data (for example, several hundred gigabytes of data). However, the external storage units 11 and 14 are not limited to this. Each of the external storage units 11 and 14 may be an optical disc, such as a digital versatile disc-recordable (DVD-R), a digital versatile disc-read only memory (DVD-ROM), a digital versatile disc-random access memory (DVD-RAM), a compact disc-recordable (CD-R), or a compact disc-read only memory (CD-ROM).

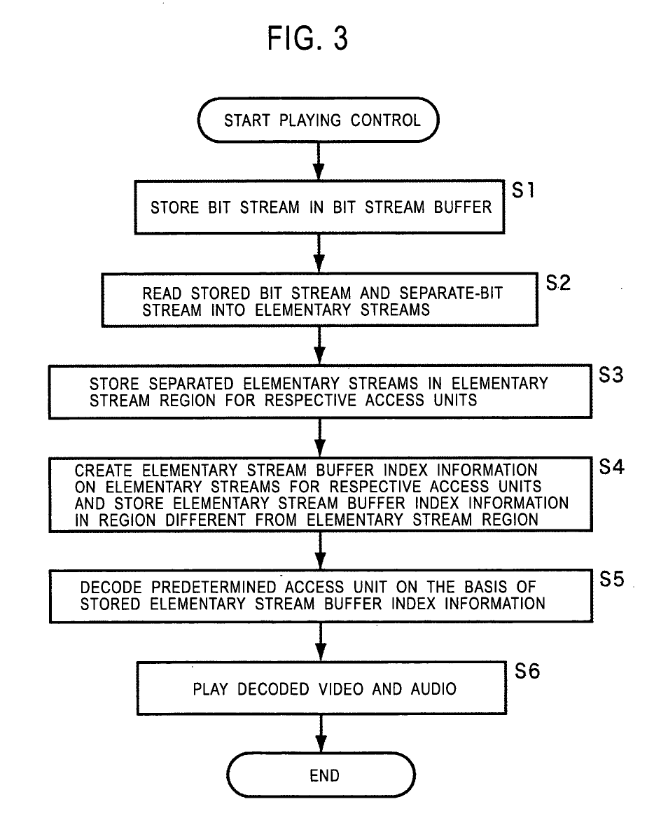

Playing control processing performed by the playing control part 12 of the reader/player 1 will now be described with reference to a flowchart shown in FIG. 3. This processing starts when a user operates an operation unit (not shown) to input an operation signal indicating an instruction for the playing control processing.

In step S1, the demultiplexer 22 causes a bit stream recorded in the external storage unit 11 to be stored in the bit stream buffer 21. In step S2, the demultiplexer 22 reads the bit stream stored in the bit stream buffer 21 by step S1 and separates the bit stream into video and audio elementary streams by predetermined demultiplexing processing.

In step S3, the demultiplexer 22 stores the elementary streams separated by step S2 in the elementary stream region 23A of the elementary stream buffer 23 for respective access units. In step S4, the demultiplexer 22 creates elementary stream buffer index information on the respective elementary streams stored in the elementary stream region 23A of the elementary stream buffer 23 by step S3 for respective access units, and stores the created elementary stream buffer index information in the elementary stream buffer index information region 23B, which is different from the elementary stream region 23A storing the elementary streams.

In step S5, the decoder 24 reads a predetermined access unit stored in the elementary stream region 23A of the elementary stream buffer 23 by step S3 in accordance with the elementary stream buffer index information stored in the elementary stream buffer index information region 23B of the elementary stream buffer 23 by step S4, and decodes the access unit using the MPEG system. In step S6, the decoder 24 outputs the baseband video signal decoded by step S5 to the display via the video output terminal to be played and outputs the baseband audio signal decoded by step S5 to the speaker via the audio output terminal to be played.

Accordingly, the use of the elementary stream buffer index information enables stream decoding for each access unit.

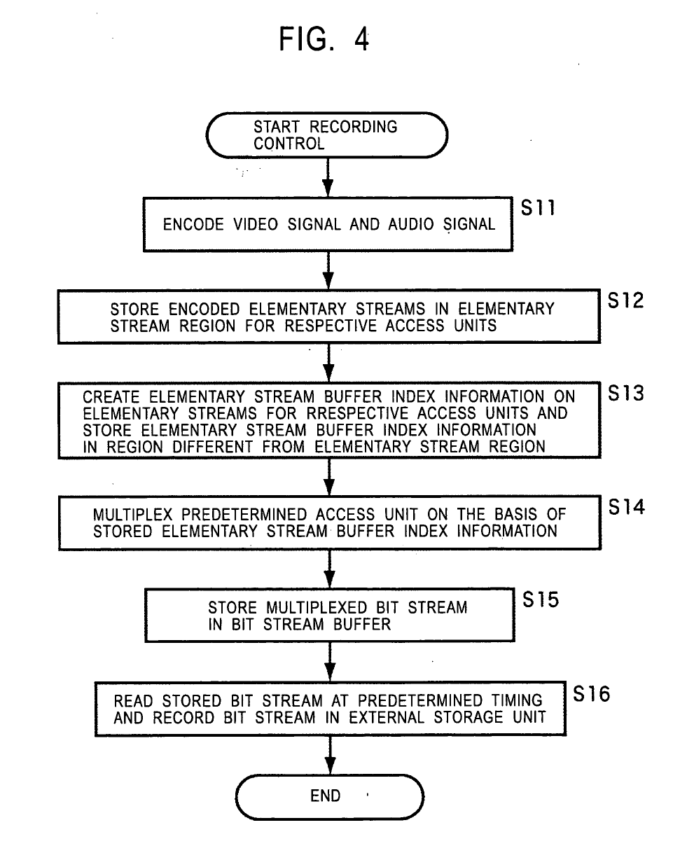

Recording control processing performed by the recording control part 13 of the reader/player 1 will now be described with reference to a flowchart shown in FIG. 4. This processing starts when a user operates an operation unit (not shown) to input an operation signal indicating an instruction for the recording control processing.

In step S11, the encoder 31 encodes input video and audio signals using the MPEG system to create elementary streams for respective access units. In step S12, the encoder 31 stores the elementary streams encoded by step S11 in the elementary stream region 32A of the elementary stream buffer 32 for respective access units.

In step S13, the encoder 31 creates elementary stream buffer index information on the elementary streams stored in the elementary stream region 32A of the elementary stream buffer 32 by step S12 for respective access units, and stores the elementary stream buffer index information in the elementary stream buffer index information region 32B, which is different from the elementary stream region 32A storing the elementary streams.

In step S14, the multiplexer 33 reads a predetermined access unit stored in the elementary stream region 32A of the elementary stream buffer 32 by step S12 in accordance with the elementary stream buffer index information stored in the elementary stream buffer index information region 32B of the elementary stream buffer 32 by step S13, and multiplexes the access unit into a bit stream by predetermined multiplexing processing.

In step S15, the multiplexer 33 stores the bit stream multiplexed by step S14 in the bit stream buffer 34. In step S16, the multiplexer 33 reads the bit stream stored in the bit stream buffer 34 by step S15 at a predetermined timing to be stored in the external storage unit 14.

Accordingly, the use of the elementary stream buffer index information enables stream encoding for each access unit.

In the reader/player 1 described above, elementary stream buffer index information created by each of the playing control part 12 (decoding side) and the recording control part 13 (encoding side) has the same format and the elementary stream buffer index information is stored in buffers so as to be separated from elementary streams. Thus, the decoder 24 or the multiplexer 33 is capable of directly accessing an access unit in accordance with the index information. Therefore, positional information to each access unit on the memory is readily acquired even for random access. This increases the processing speed as compared with a search by sequential playing on the elementary streams.

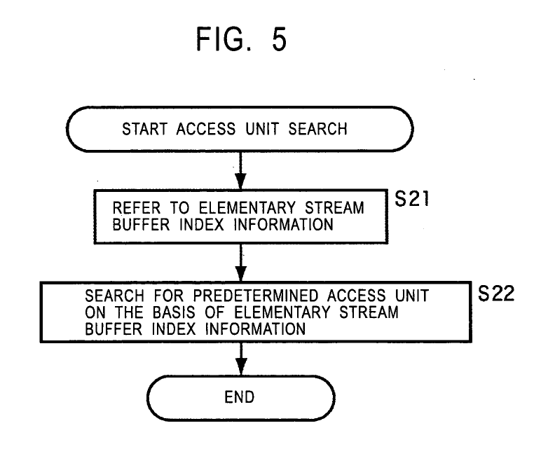

Access unit search processing performed by the playing control part 12 of the reader/player 1 will now be described with reference to a flowchart shown in FIG. 5. This processing starts when a user operates an operation unit (not shown) to input an operation signal indicating an instruction for the access unit search processing.

In step S21, the decoder 24 refers to the elementary stream buffer index information stored in the elementary stream buffer index information region 23B of the elementary stream buffer 23. In step S22, the decoder 24 searches for a desired access unit stored in the elementary stream region 23A of the elementary stream buffer 23 in accordance with an entry point included in the elementary stream buffer index information referred to by step S21.

For example, for an MPEG2 video stream or the like, an encoding image (I picture) within a frame is defined as an entry point for random access, and the elementary stream buffer index information includes the type of the picture, the PTS, the DTS, and the like. Thus, accessing the elementary stream buffer index information realizes detection of the entry point. Accordingly, a desired access unit can be readily searched for in accordance with the entry point.

Also, since the elementary streams are not accessed, the necessity of parsing processing (in other words, PES header analysis) is eliminated, thus realizing efficient search processing.

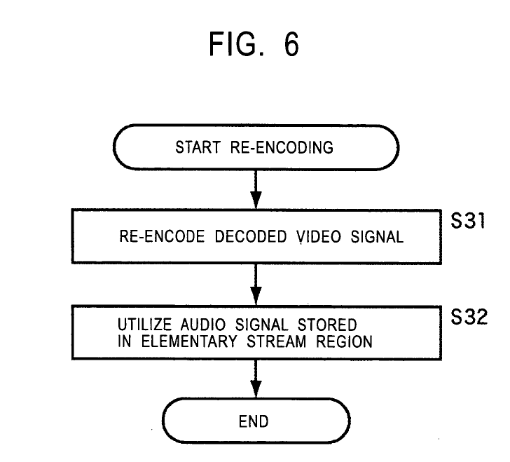

Re-encoding processing performed by the recording control part 13 of the reader/player 1 will now be described with reference to a flowchart shown in FIG. 6. This processing starts when a user operates an operation unit (not shown) to input an operation signal indicating an instruction for the re-encoding processing.

In step S31, the encoder 31 re-encodes the video signal decoded by the decoder 24 using the MPEG system to create an elementary stream. In step S32, the encoder 31 utilizes the audio elementary stream held in the elementary stream region 32A of the elementary stream buffer 32 by the primary encoding.

Accordingly, without decoding all the video and audio elementary streams to baseband signals and re-encoding them, only the decoded video signal is re-encoded and the audio encoded by the primary encoding is utilized. Thus, the redundancy of the processing is reduced and the deterioration of the quality of audio can be prevented.

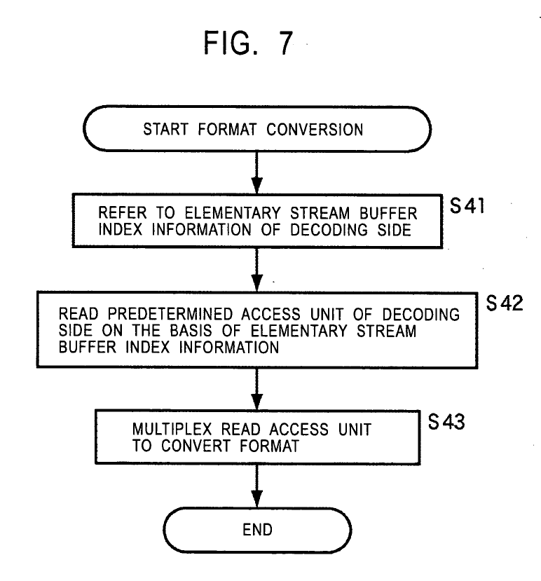

Format conversion processing performed by the recording control part 13 of the reader/player 1 will now be described with reference to a flowchart shown in FIG. 7. This processing starts when a user operates an operation unit (not shown) to input an operation signal indicating an instruction for the format conversion processing.

In step S41, the multiplexer 33 refers to the elementary stream buffer index information stored in the elementary stream buffer index information region 23B of the elementary stream buffer 23 of the decoding side. In step S42, the multiplexer 33 reads a desired access unit stored in the elementary stream region 23A of the elementary stream buffer 23 of the decoding side in accordance with the elementary stream buffer index information referred to by step S41.

In step S43, the multiplexer 33 multiplexes the access unit read by step S42 to convert the format.

Accordingly, the elementary streams are directly multiplexed to convert the format in accordance with the elementary stream buffer index information stored in the elementary stream buffer of the decoding side. Thus, the redundancy of the processing can be reduced.

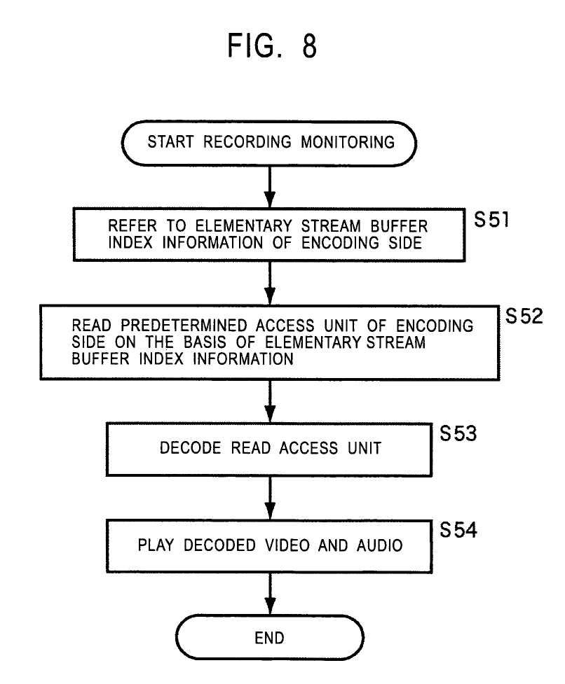

A recording monitoring processing performed by the playing control part 12 of the reader/player 1 will now be described with reference to a flowchart shown in FIG. 8. This processing starts when a user operates an operation unit (not shown) to input an operation signal indicating an instruction for the recording monitoring processing.

In step S51, the decoder 24 refers to the elementary stream buffer index information stored in the elementary stream buffer index information region 32B of the elementary stream buffer 32 of the encoding side. In step S52, the decoder 24 reads a predetermined access unit (in other words, an access unit being recorded) stored in the elementary stream region 32A of the elementary stream buffer 32 of the encoding side in accordance with the elementary stream buffer index information referred to by step S51.

In step S53, the decoder 24 decodes the predetermined access unit read by step S52 using the MPEG system. In step S54, the decoder 24 outputs the baseband video signal decoded by step S53 to the display via the video output terminal to be played and outputs the baseband audio signal decoded by step S53 to the speaker via the audio output terminal to be played.

Accordingly, without separating a bit stream being recorded into elementary streams and decoding them to be monitored, elementary streams are directly decoded in accordance with elementary stream buffer index information stored in the elementary stream buffer of the encoding side to be monitored. Thus, there is no need to operate the demultiplexer 22. Therefore, the processing load can be reduced.

As described above, this embodiment establishes common interfaces between the playing control part 12 (decoding side) and the recording control part 13 (encoding side) and stores elementary stream buffer index information in buffers so as to be separated from an elementary stream. Thus, direct access to an access unit can be realized in accordance with the index information. Therefore, the speed of processing, such as re-encoding and format conversion, is increased, and central processing unit (CPU) resources and memory resources can be efficiently used.

The series of processing described above can be performed by hardware or software. When the series of processing described above is performed by software, a program constituting the software is installed via a network or a recording medium on a computer built in dedicated hardware or a general-purpose personal computer or the like capable of performing various functions by installing various programs. Accordingly, the functions of the reader/player 1 are realized.

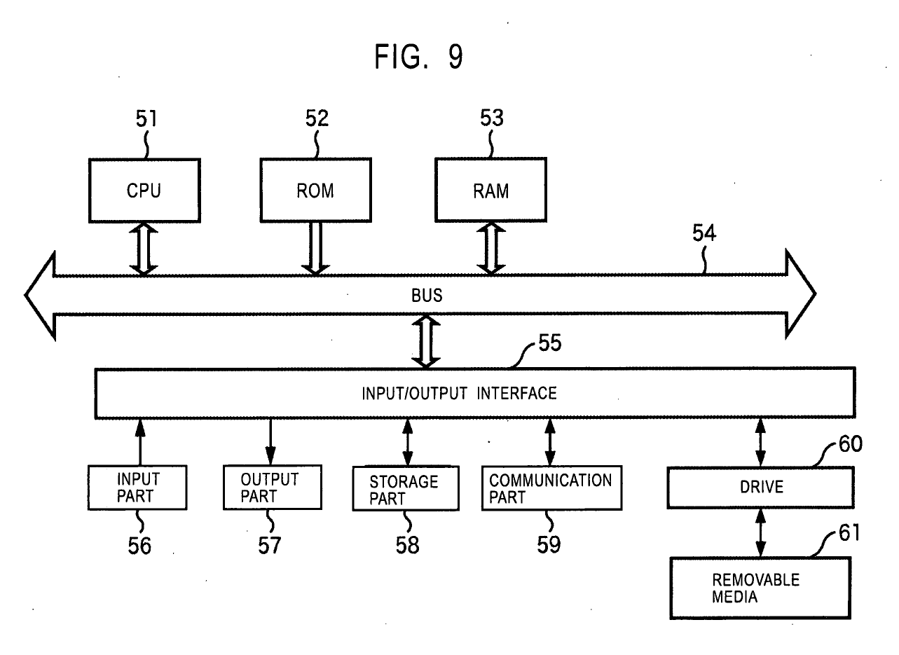

FIG. 9 shows an example of the structure of a computer functioning as the reader/player 1 described above. A CPU 51 of the computer performs various types of processing in accordance with a program stored in a read only memory (ROM) 52 or a program loaded on a random access memory (RAM) 53 from a storage part 58. Data or the like necessary for the CPU 51 to perform various types of processing is also appropriately stored in the RAM 53.

The CPU 51, the ROM 52, and the RAM 53 are connected to each other via a bus 54. An input/output interface 55 is also connected to the bus 54.

The input/output interface 55 is connected to an input part 56 including a button, a switch, a keyboard, or a mouse, an output part 57 including a display, such as a cathode ray tube (CRT) display or a liquid crystal display (LCD), and a speaker, the storage part 58 including a hard disk, and a communication part 59 including a modem and a terminal adaptor. The communication part 59 performs communication via a network including the Internet.

A drive 60 is connected to the input/output interface 55 as necessary, and removable media 61 including a magnetic disc, an optical disc, a magneto-optical disc, or a semiconductor memory is also appropriately mounted on the input/output interface 55. A computer program read from the drive 60 or the removable media 61 is installed on the storage part 58.

As shown in FIG. 9, a recording medium installed on a computer and recording a program executable by the computer not only includes the removable media 61, such as a magnetic disc (including a flexible disc), an optical disc (including a compact disc-read only memory (CD-ROM) and a digital versatile disc (DVD)), a magneto-optical disc (including a MiniDisc (MD) (registered trademark)), or a semiconductor memory, which records the program and is distributed in order to provide the program to a user independent of an apparatus main unit, but also includes the ROM 53 or the storage part 58, such as a hard disk, which records the program and is built in the apparatus main unit to be provided to the user.

In this specification, steps for a program stored in a program storage medium are not necessarily performed in chronological order in accordance with the written order. The steps may be performed in parallel or independently without being performed in chronological order.

What is claimed is:

1. An encoder comprising:
encoding means for encoding an input video or audio signal into an elementary stream;
creating means for creating elementary stream buffer index information on the elementary stream; and
storing means for storing the elementary stream encoded by the encoding means and the elementary stream buffer index information created by the creating means.

2. An encoder according to claim 1, wherein the elementary stream and the elementary stream buffer index information are stored in different regions.

3. An encoder according to claim 1, wherein the encoding means encodes the video or audio signal into the elementary stream for each access unit,
wherein the creating means creates the elementary stream buffer index information for each access unit, and
wherein the storing means stores the elementary stream and the elementary stream buffer index information for each access unit.

4. An encoding method comprising:
an encoding step of encoding an input video or audio signal into an elementary stream;
a creating step of creating elementary stream buffer index information on the elementary stream; and
a storage controlling step of controlling storage of the elementary stream encoded by the encoding step and the elementary stream buffer index information created by the creating step.

5. A decoder comprising:
storing means for storing an elementary stream and elementary stream buffer index information on the elementary stream; and
decoding means for decoding the elementary stream in accordance with the elementary stream buffer index information stored in the storing means.

6. A decoder according to claim 5, wherein the elementary stream and the elementary stream buffer index information are stored in different regions.

7. A decoder according to claim 5, wherein the storing means stores the elementary stream and the elementary stream buffer index information for each access unit, and
wherein the decoding means decodes the elementary stream for each access unit.

8. A decoding method comprising:
a storage controlling step of controlling storage of an elementary stream and elementary stream buffer index information on the elementary stream; and
a decoding step of decoding the elementary stream in accordance with the elementary stream buffer index information stored by the storage controlling step.

9. A recorder comprising:
encoding means for encoding an input video or audio signal into an elementary stream;
first storing means for storing the elementary stream encoded by the encoding means;
creating means for creating elementary stream buffer index information on the elementary stream;
second storing means for storing the elementary stream buffer index information created by the creating means;
multiplexing means for multiplexing the elementary stream stored in the first storing means in accordance with the elementary stream buffer index information stored in the second storing means; and
recording means for recording a bit stream multiplexed by the multiplexing means in an external storage unit.

10. A recorder according to claim 9, wherein the encoding means encodes the video or audio signal into the elementary stream for each access unit,
wherein the first storing means stores the elementary stream for each access unit,
wherein the creating means creates the elementary stream buffer index information for each access unit,
wherein the second storing means stores the elementary stream buffer index information for each access unit, and
wherein the multiplexing means multiplexes the elementary stream for each access unit.

11. A recorder according to claim 9, wherein the multiplexing means multiplexes an elementary stream of a decoding side in accordance with elementary stream buffer index information of the decoding side.

12. A recording method comprising:
an encoding step of encoding an input video or audio signal into an elementary stream;
a first storage controlling step of controlling storage of the elementary stream encoded by the encoding step;
a creating step of creating elementary stream buffer index information on the elementary stream;
a second storage controlling step of controlling storage of the elementary stream buffer index information created by the creating step;
a multiplexing step of multiplexing the elementary stream stored by the first storage controlling step in accordance with the elementary stream buffer index information stored by the second storage controlling step; and
a recording controlling step of controlling recording of a bit stream multiplexed by the multiplexing step in an external storage unit.

13. A player comprising:
separating means for separating a bit stream recorded in an external storage unit into elementary streams;
first storing means for storing the elementary streams separated by the separating means;
creating means for creating elementary stream buffer index information on the elementary streams;
second storing means for storing the elementary stream buffer index information created by the creating means;
decoding means for decoding the elementary streams stored in the first storing means in accordance with the elementary stream buffer index information stored in the second storing means; and
playing means for playing a video or audio signal decoded by the decoding means.

14. A player according to claim 13, wherein the first storing means stores each of the elementary streams for each access unit,
wherein the creating means creates the elementary stream buffer index information for each access unit,
wherein the second storing means stores the elementary stream buffer index information for each access unit, and
wherein the decoding means decodes each of the elementary streams for each access unit.

15. A player according to claim 13, wherein the decoding means decodes an elementary stream of an encoding side in accordance with elementary stream buffer index information of the encoding side.

16. A playing method comprising:
a separating step of separating a bit stream recorded in an external storage unit into elementary streams;
a first storage controlling step of controlling storage of the elementary streams separated by the separating step;
a creating step of creating elementary stream buffer index information on the elementary streams;
a second storage controlling step of controlling storage of the elementary stream buffer index information created by the creating step;
a decoding step of decoding the elementary streams stored by the first storage controlling step in accordance with the elementary stream buffer index information stored by the second storage controlling step; and
a playing controlling step of controlling playing of a video or audio signal decoded by the decoding step.
